(19) United States
(12) Patent Application Publication
(10) Pub. No.: US 2014/0125092 A1
(43) Pub. Date: May 8, 2014

(54) STOWAGE MONUMENT

(71) Applicant: DRIESSEN AIRCRAFT INTERIOR SYSTEMS, INC., Garden Grove, CA (US)

(72) Inventors: Tom Schreuder, Wassenaar (NL); Peter Detjen, Hamburg (DE); Mehrnoush Zare, Tustin, CA (US)

(73) Assignee: DRIESSEN AIRCRAFT INTERIOR SYSTEMS, INC., Garden Grove, CA (US)

(21) Appl. No.: 14/071,696

(22) Filed: Nov. 5, 2013

Related U.S. Application Data
(60) Provisional application No. 61/722,336, filed on Nov. 5, 2012.
(60) Provisional application No. 61/729,485, filed on Nov. 23, 2012.

(51) Int. Cl. B64D 11/04; B64D 11/06; B64D 9/00; A47B 83/00

(52) U.S. Cl. CPC B64D 11/04; A47B 83/00; B64D 11/06; B64D 9/00
USPC 297/163; 312/235.4; 29/401.1

(57) ABSTRACT

Embodiments of the present invention relate generally to improved monuments for use in aircraft and other passenger transport vehicles. The monument provides improved storage options for space-saving on-board the vehicle.

### CROSS REFERENCE TO RELATED APPLICATIONS

This application claims the benefit of U.S. Provisional Application Ser. No. 61/722,336, filed Nov. 5, 2012, titled “Galley/Stowage Monument with Cabin Attendant Seats,” and U.S. Provisional Application Ser. No. 61/729,485, filed Nov. 23, 2012, titled “Boeing 737 SFE AFT Galley/Lavatory Proposal,” the entire contents of each of which are hereby incorporated by reference.

### FIELD OF THE INVENTION

Embodiments of the present invention relate generally to improved monuments for use in aircraft and other passenger transport vehicles. The monuments provide improved storage options for saving space on-board the vehicle.

### BACKGROUND

Maximizing space usage on-board passenger transport vehicles is of utmost importance to aircraft and vehicle interior designers, as well as the transportation companies. It has been found that saving even a few inches of space per area can translate to the ability to add one or more passenger seats, which adds revenue to a company's bottom line. The practice of optimizing space has been found to be particularly useful for aircraft companies and designers. Aircraft galleys, lavatories, and other common spaces are areas where the present assignee has been examining space optimization. Rather than simply putting the seats closer together, a creative exploration of unused spaces can add increased space without sacrificing passenger comfort.

### BRIEF SUMMARY

Embodiments of the invention described herein thus provide improved monuments for use in aircraft and other passenger transport vehicles. The monuments provide improved storage options for saving space on-board the vehicle. In one embodiment, the monuments include a modifiable partition that can be installed at various locations in the aircraft and that can have one or more additional storage options installed thereto in a modular fashion. Some embodiments of the monuments have a clearance space so they can be installed even in locations where overhead compartments are located. In other embodiments, the monuments provide hidden storage behind cabin attendant seat headrests. The headrests may fold down to reveal a countertop space, as well as interior storage for storage compartments and/or galley components and/or any other items to be stored.

### BRIEF DESCRIPTION OF THE DRAWINGS

FIG. 1 shows a front perspective view of one embodiment of a monument according to certain embodiments of the invention.

FIG. 2 shows a front perspective view of one embodiment of a monument with double sized storage options on one side thereof.

FIG. 3 shows a front perspective view of an alternate embodiment of a monument according to certain embodiments of the invention.

FIG. 4 shows a front perspective view of a further embodiment of a monument having a hidden headrest storage space.

FIG. 5 shows a front perspective view of the monument of FIG. 4 with the headrests being opened to reveal the storage space.

FIG. 6 shows a front perspective view of the monument of FIG. 4 with the headrests in the open position to provide a countertop work space.

FIGS. 7A-C shows a front perspective view of an alternate monument with larger storage space and a cover panel provided.

FIG. 8 shows a front perspective view of one embodiment of an alternate monument.

FIG. 9 shows a front perspective view of the monument of FIG. 8 with the headrests being opened to reveal the storage space.

FIG. 10 shows a front perspective view of the monument of FIG. 8 with the headrests in the open position to provide a countertop work space.

FIG. 11 shows a front view of a re-configurable partition.

### DETAILED DESCRIPTION

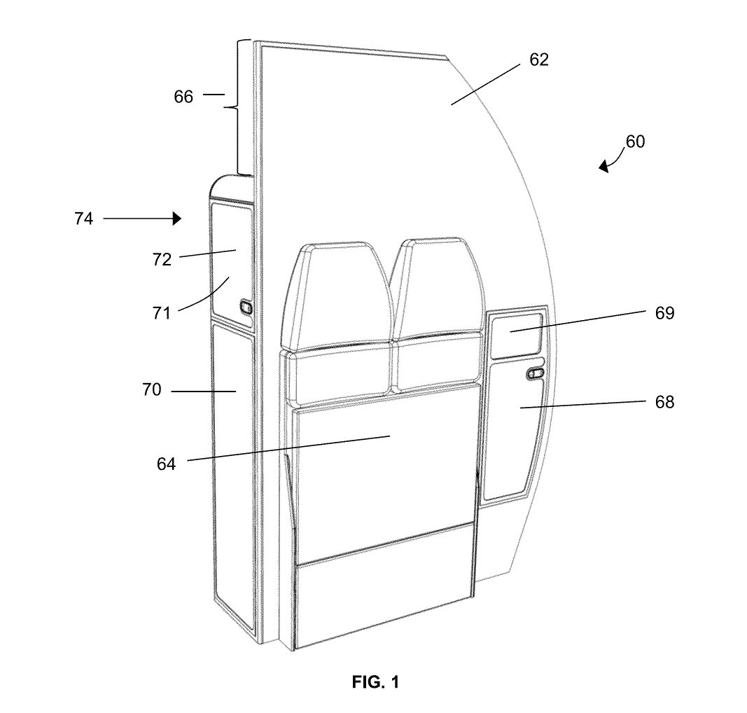

One embodiment of the space saving features provided is an improved stowage monument that can be designed for positioning at various areas on the aircraft. Storage and galley monuments are generally large structures that can be used for on-board storage. They are provided as inserts that are designed for positioning in the aircraft cabin. In the embodiment shown in FIG. 1, one embodiment of the improved monument 60 includes a full height wind screen or partition 62. The partition 62 may be modifiable in a number of ways. For example, it may have one or more storage components mounted thereto, it may have one or more cabin attendant seats mounted thereto, it may have one or more cabin seat headrest storage positions, it may have a waste compartment, it may have a display component, and so forth. These components may be mounted to the partition in modifiable fashion so that airline preference may be accommodated and so that the interior of the aircraft can be modified as flight and storage requirements change. The partition 62 may be installed as a typical aircraft partition such that it transfers the load to the seat tracks and aircraft wall, while supporting the components mounted thereto. The partition may have an attachment system for securing the partition at its base to a seat track and at its upper portion to a regular upper attachment of the vehicle or aircraft. (The storage compartments that may be secured to the partition may have an additional attachment system for securing the one or more storage compartments to a seat track.)

In the specific embodiment shown, the partition 62 is shown with a double cabin attendant seat 64, clearance space 66 for under bin storage compartments, a waste compartment 68 and opening chute 69, and a lower storage space area 70 and upper storage space area 72. The lower storage space area 70 and the upper storage space area 72 are shown as positioned along one side of the partition 62, with their access areas generally on the interior cabin-facing side 74 of the monument 60. The areas 70, 72 are generally closed via door panels 71 with appropriate locking systems to contain the contents of the storage space areas 70, 72 and to achieve a more elegant look to the space. The door panel 71 generally has a lock or securing feature in accordance with aviation regulations to ensure that it stays closed and secured and stores items appropriately.

In a particular embodiment, the lower storage space area 70 is sized and configured to store one or more of an on-board wheelchair, a personal wheelchair, a serving trolley, passenger items, such as coats and larger carry-on items, or any other items that may need to be stored. The upper storage space areas 72 may be sized and configured to hold one or more of an on-board wheelchair, pillows and blankets, extra galley supplies and serving items, first-aid items, passenger items, combinations thereof, or any other items. The items in areas 70, 72 may be stored side by side or back to back.

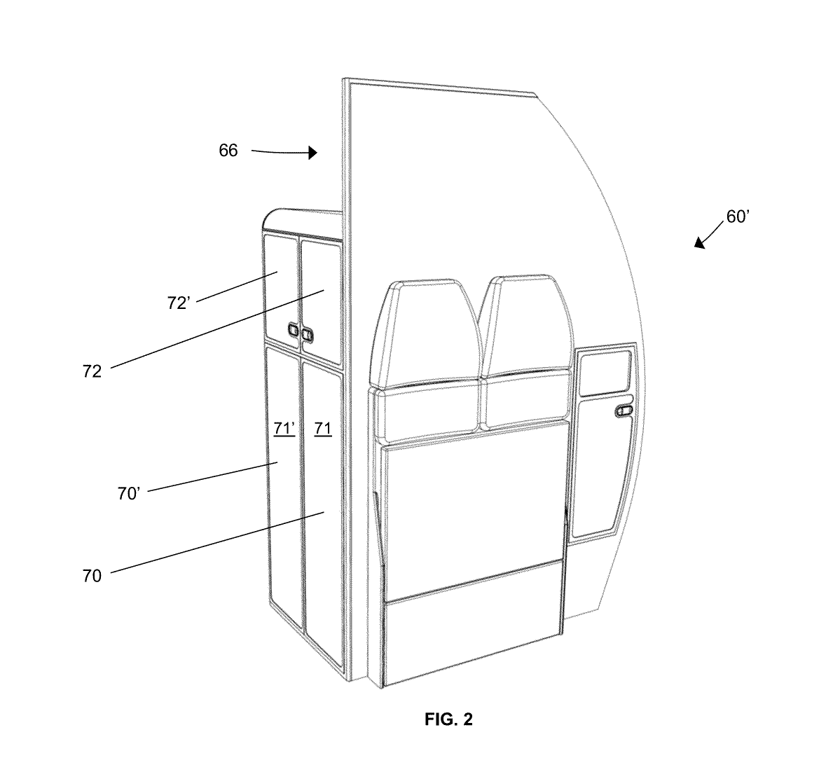

The width of the monument 60 may vary by need and by airline requirements. In one embodiment, the monument 60 can vary from about five inches in width, up to about 40 inches in width. In a specific embodiment, the monument 60 is about ten inches wide. In another embodiment, the monument 60 is about fifteen inches wide. In a further embodiment, the monument is about 28 inches wide. In further embodiments, the monument 60 may be even wider, depending upon the desired use. For the embodiments that are wide enough, the storage space areas 70, 72 may actually be provided as double storage space areas 70, 70′, 72, 72′, as shown in FIG. 2. These double storage areas of the modified monument 60′ may be divided by an internal divider or they may be provided as an undivided interior. Double doors 71, 71′ may be provided as shown, or single larger doors may be provided, or a combination thereof. (For example, the upper storage areas 72, 72′ may have double doors while the lower storage areas 70, 70′ may have a single large door, or vice versa.)

One advantage of the monuments 60, 60′ described is that they provide a partition 62 with a cabin attendant seat 64 and/or storage spaces 70, 72 that can be installed anywhere in the aircraft. If desired, the monument can be installed at the back of the aircraft. Additionally or alternatively, many aircraft have rows of seats that can be removed and replaced to change the configuration of the aircraft. One of the monuments described herein may be installed where a row of seats has been removed. For example, in one aspect, the partition 62 can be installed into the seat tracks, such that the partition supports the load of the other components that may be removably mounted onto the partition. If provided, the storage compartments 70, 72 may be mounted to the partition 62 to form a monument with a clearance space 66 provided above the storage compartments on allow the monument to be installed without interfering with the overhead storage compartments. This could allow the monument to be installed between a series of seats and function as a cabin divider. This design provides the airline with flexibility depending upon its route and its needs. For example, if an aircraft needs additional storage and additional attendant seating in a particular location, it can efficiently install a partition 62 with the option to add storage compartments 70, 72 and/or attendant seating in order to provide a stowage monument at that location.

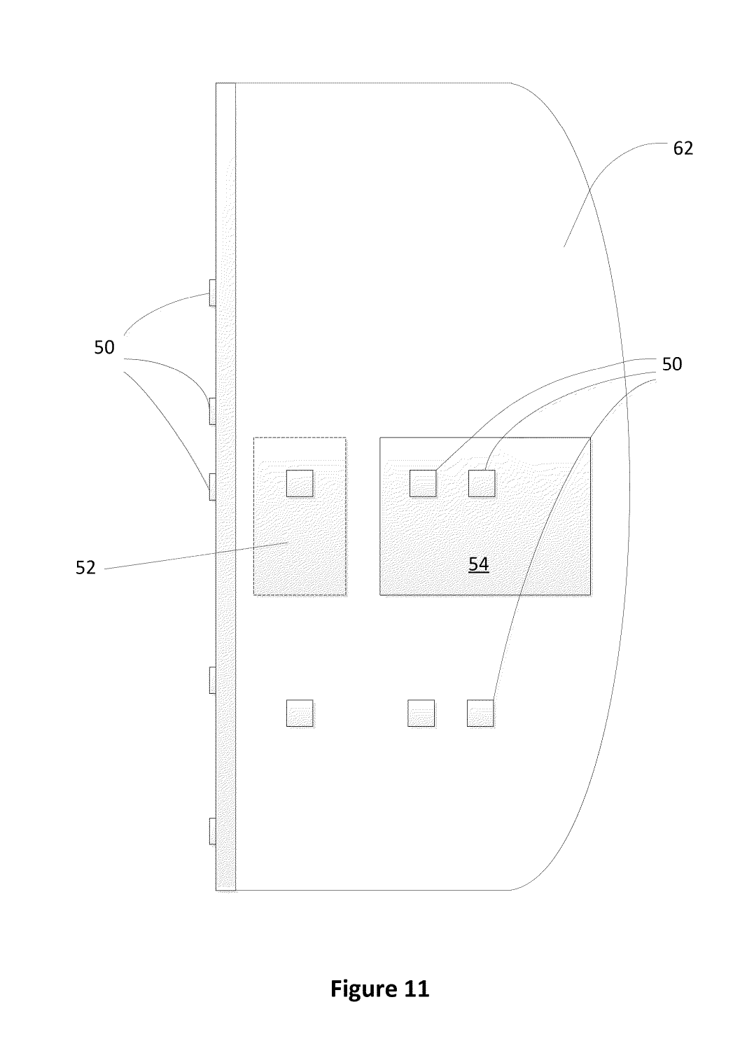

In general, the monuments described herein provide options for reconfiguring the aircraft, as desired. For example, some airlines may run shorter flight routes in the summer (e.g., for European vacationing) and revert back to longer routes in the winter (e.g., for overseas travel). On shorter or summer routes of about one or two hours in duration, when passengers do not carry as much baggage, a partition 62 without the extra seating 64 and storage 70, 72 mounted thereto may be installed. One example of such a partition 62 is shown in FIG. 11. This may allow space for an extra row of seats. In this instance, the mounting areas 50 on the partition 62 that would otherwise be used to mount the storage compartments 70, 72 and/or the attendant seating unit 64, may be used for mounting an emergency adapter plate 52. (Certain emergency equipment is always required on-board, so the adapter plate 52 for the emergency equipment may be mounted or otherwise attached directly onto one side of the partition.) When using partition 62 on its own, it may also be provided with an optional fold-down table 54, which is a hinged panel portion of the partition that can fold down for use as a table. A blind-panel may be installed on the opposite side of the partition 62 (e.g., where normally the stowage components would be mounted to the partition), allowing the use of the fold-down table 54 and blocking the opening from the other side of the partition.

For longer flights (e.g., in the winter) when passengers tend to carry more baggage and need more storage space, the storage components and/or the attendant seats may be mounted onto the partition 62 as shown in FIGS. 1-2. For example, the extra or last row of seats may be removed, the partition 62 may remain in place, the blind-panel (if used) may be removed, the adapter plate 52 (if used) may be removed, and the storage compartments 70, 72 may be mounted to the partition at appropriate mounting areas or attachment points. (The emergency adapter plate can be moved from the partition 62 onto another area of the monument.) Thus, instead of the current method of mounting a stand-alone stowage unit, which requires a one inch space in the stowage unit and an aircraft partition, the monuments described herein provide an integral modular partition 62 that may be reconfigurable as desired. The partition 62 may be pre-configured to receive a number of optional arrangements for the storage compartments and seating. The partition 62 may have a series of mounting areas 50 that are configured to receive one or more modular components secured thereto.

In one embodiment, the monument 60, 60′ can be used in place of a traditional aircraft partition or divider. In one embodiment, monument 60, 60′ is used to separate cabin segments. It may act as a partition wall, but rather than only serving the partitioning function, the monument may also provide additional storage, attendant seating and/or waste collection options. These features may be customizable, depending upon what the airline's particular needs entail. For example, the seats 64 may not be required on every partition 62, a single seat may be desired, or more than two seats may be desired. The waste bin 68 may not be required, or the storage units 70, 70′, 72, 72′ may not be required. Providing customizable options allows the airline to determine and meet its needs.

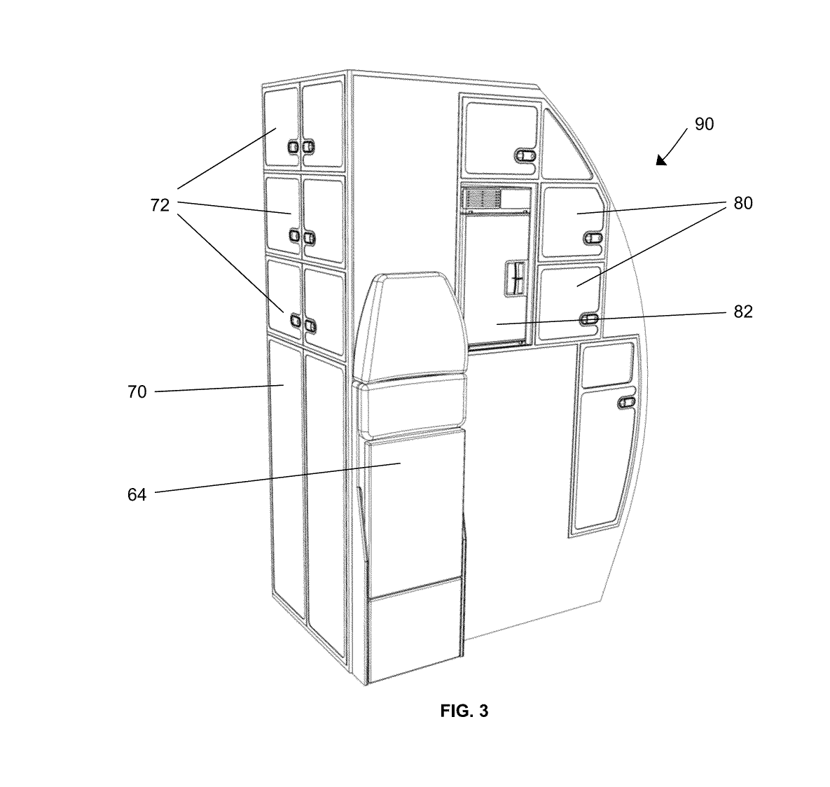

In an even further embodiment shown in FIG. 3, an alternate monument 90 may have a single cabin attendant seat 64, multiple upper and lower side storage areas 70, 72, as well as front storage areas 80 and a front opening for a galley component 82. Due to space considerations and the amount of storage provided (and required for this design), this monument design is designed as a full height monument 90 (without the modular partition 62 option). It may be installed near a galley or any other location where the clearance space 66 is not needed, but where additional upper storage space 72 is needed. The galley component 82 provided in this monument 90 may be an oven, a beverage chiller, a beverage maker, or any other appropriate component. Although one component 82 is shown, it should be understood that additional components may be provided as well. For example, a second component 82 may be provided in place of front storage areas 80. Additionally or alternatively, a component 82 may be provided in place of side storage units 70, 72. Additionally or alternatively, a component 82 may be provided near the attendant seat 64 (and/or in place of the waste bin, and so forth).

Providing a component 82 that would normally be positioned in the galley on the monument 90 can help save space in the galley and can help ease the catering process. For example, if the monument 90 is positioned in the aircraft at a location that is distant from a full galley, the galley component 82 can prevent the attendant from having to walk all the way back to the galley. If the component 82 is an oven, catering can be eased by having a series of meals in the vicinity of the monument 90. If the component 82 is a chiller, catering can be eased by having chilled wine or cocktail mixers in the vicinity of the monument 90. If the component 82 is a beverage maker, catering can be eased by having fresh espresso, coffee, or tea available in the vicinity of the monument 90. Other options for the component 82 are obviously possible and considered within the scope of this disclosure.

In another embodiment, the component 82 may also be positioned in one or more of the monuments 60, 60′ described. Anywhere a storage space is provided, the items or components put therein may vary depending upon the aircraft design.

Embodiments of the present invention also provide improved storage options and features where the cabin attendant seats are positioned. Currently, there is no additional functionality at that space. The headrests of the attendant seats are typically positioned at the front of a galley monument. When the attendant seats are not in use, the chair portions of the seats are positioned upright so that they lie flat against the monument. When the seats are in use, the seat portions pull out to provide seating. The headrests remain in their stationary positions, whether the seats are in use or not. The space behind the headrests is unused space.

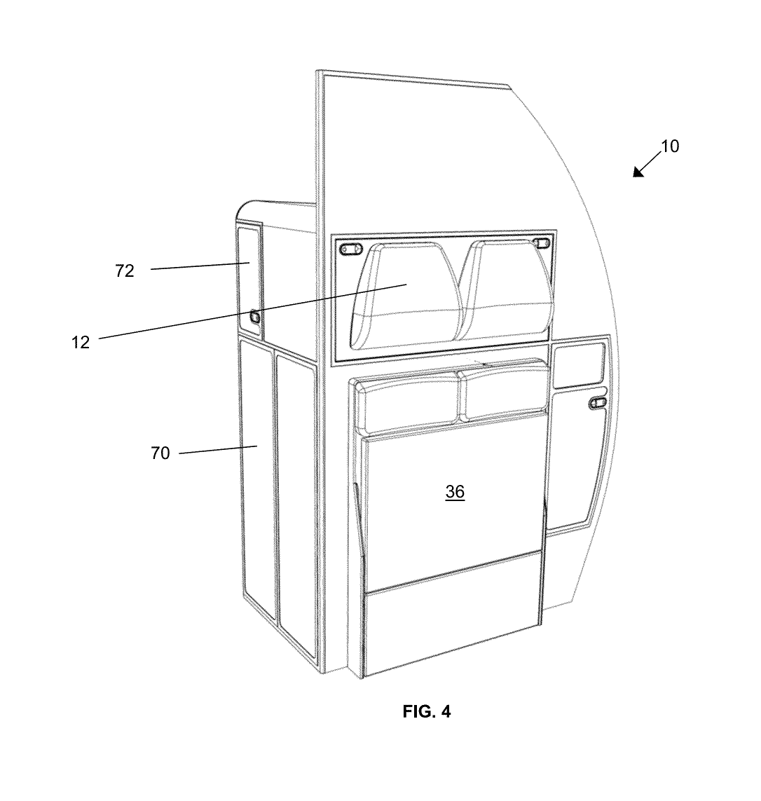

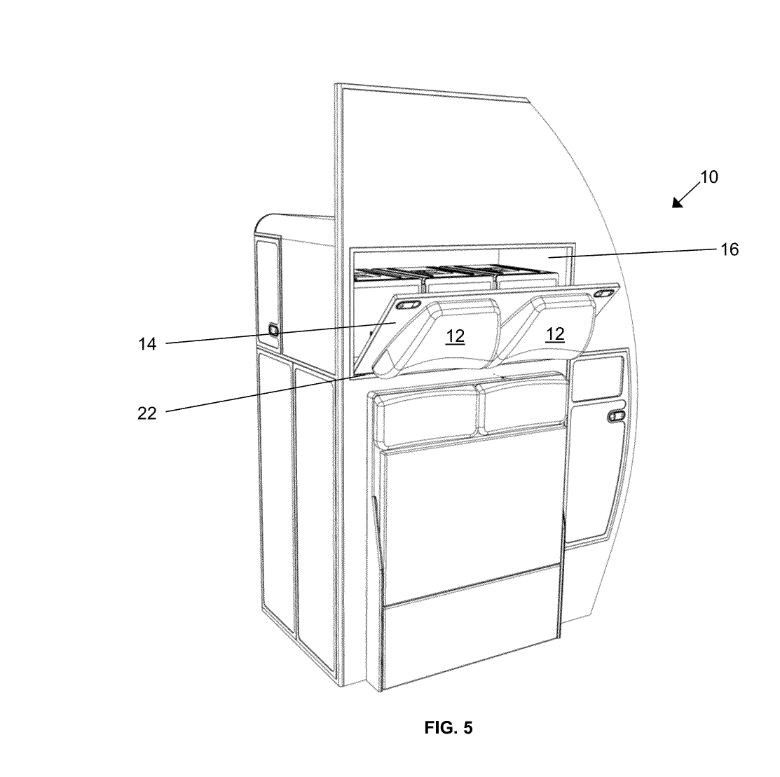

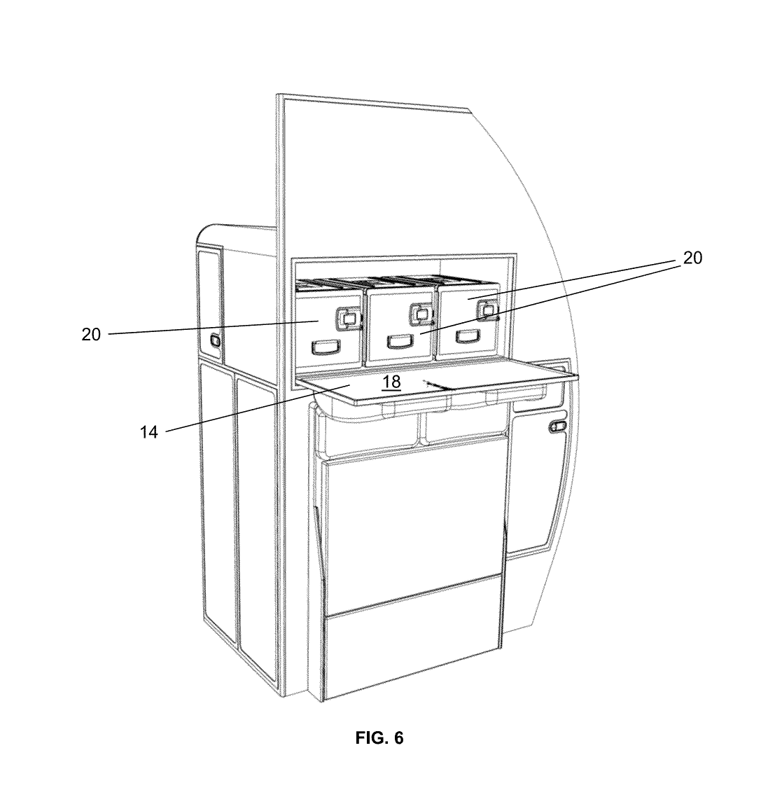

However, as shown in FIG. 4, in one embodiment, there is provided an improved monument 10 with a hidden headrest storage area. This monument 10 provides the typical attendant seat bottom portion 36, but provides an improved storage option behind the headrest portion 12. As shown in FIG. 5, the headrests 12 are secured to a panel back 14. The panel back 14 may pull or fold down at a hinged portion 22 to reveal a storage space 16. In the lowered position of FIG. 6, the panel back 14 of the folded down headrests forms a countertop or work surface that is provided by the back surface 18 of the panel back 14. This surface 18 becomes a work space/countertop.

If more than one headrest 12 is present on the monument 10, it is possible for the headrests 12 to all move down together or otherwise be connected to create a single panel back 14. It is also possible for the headrests 12 to be movable individually, such that a single headrest may be opened or hinged down to reveal one part of the storage space 16 while another headrest remains in its upright position. It is also possible to provide the headrests optionally securable to one another. This can provide the option of the headrests to move together or individually for accessing space 16.

In the embodiment shown in FIGS. 4-6, the storage space 16 revealed may contain one or more storage compartments 20. These figures show three storage compartments 20, which may be standard storage units for use in aircraft. Additionally or alternatively, compartments 20 may be used for housing various small equipment or electronic components.

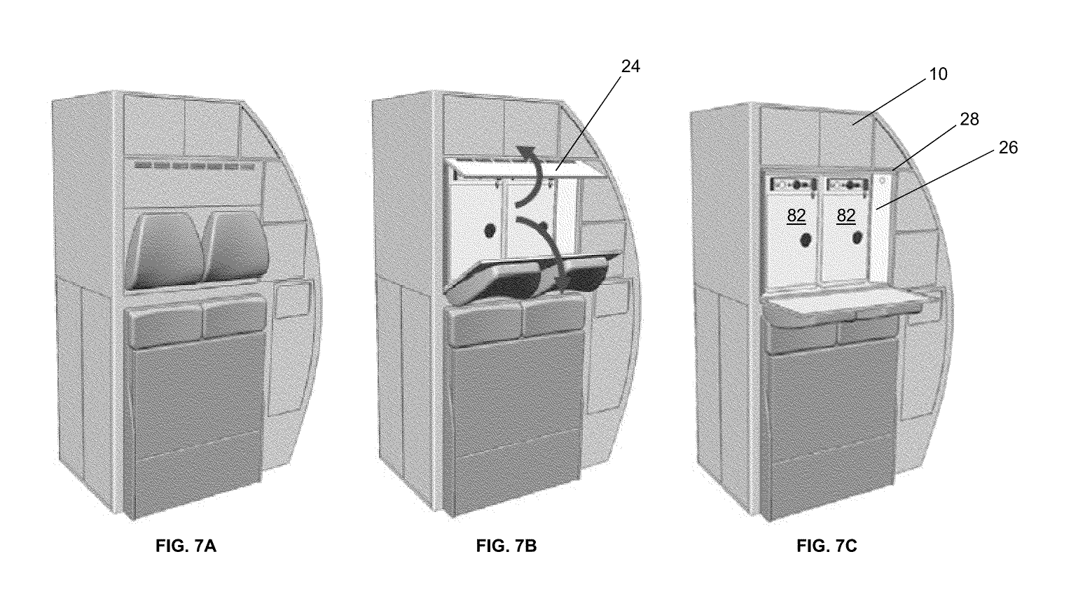

In some instances, it may be desirable to provide a larger storage space 16. For example, a storage space that has a height larger than the height of the headrests 12 may be necessary. In this instance, a cover panel 24 may be provided above the headrests 12. As shown in FIGS. 7A-C, a cover panel 24 may be opened up or removed in order to reveal one or more larger compartments 26. Cover panel 24 may be hinged, such that it opens upwardly. Cover panel 24 may be completely removable. In one embodiment, cover panel 24 opens upwardly and can be pushed back into a space 28 between upper area of the larger compartments 26 and the monument 10. Larger compartments 26 may be used for storage, such as housing storage bins. Additionally or alternatively, they may be used for housing various equipment components 82, such as ovens, chillers, coffee or beverage makers, electronic components, or any other aircraft components that may be housed in hidden headrest space 16. In the embodiment shown in FIG. 7, the larger compartments 26 are shown as housing two components 82 provided in the hidden headrest space 16.

Providing a panel back 14 of the headrests 12 that folds down to reveal a countertop space 18 allows easy access to the storage space 16 behind the headrests 12, while also providing a convenient work space. This worktop space 18 may be used for preparing beverages, meals, or any other necessary use. The worktop space 18 also helps protect or otherwise shield the attendant seats from any dirt or debris that may fall from the storage space 16 in use.

If provided, the storage compartments 20, 26 may be pulled out and accessed individually or as a group. The compartments may be a single, but wide unit that spans the distance of the storage space 16 or they may be provided as individual compartments as shown. The compartments may be standalone units that can slide or tilt out manually for access. The compartments may be positioned on a drawer-like system with a rail and roller design, such that they can slide out together or individually for access. The compartments may be connected to the hinge 22 such that opening of the panel 14 causes the compartments to open, slide or otherwise tilt out for immediate access. Any number of options for accessing the compartments are possible and considered within the scope of this invention.

FIGS. 4-7 also show the previously-described optional lower storage space 70. In this embodiment, storage space 70 may be used to store one or more of several items, such as an on-board wheelchair, a personal wheelchair, serving trolley, passenger items, such as coats and larger carry-on items, combinations thereof, or any other items that may need to be stored. Items may be stored side by side or back to back in storage space 70. An upper storage space 72 may also be provided.

Another optional feature that may be provided on an improved monument 10 is a magazine rack or display material area 76, a video monitor display 78, a shelving area for decorative items, a combination thereof, or any other desired options. The space provided on the side 74 of monument may be used for any additional storage or display options.

The features described may be used on any size, shape, or type of monument. For example, the hidden headrest storage space features may be provided on a galley monument, a wind screen monument, an under bin monument, or any other location where cabin attendant seats may be positioned or desired to be positioned. These hidden headrest storage features may be used in connection with the monuments 60, 60′, 90 described above, or they may be used as stand-alone features on currently available monument designs. For example, the monument 10 of FIGS. 4-6 has headrest storage 16 as well as a clearance space 66 so it can be installed in the cabin wherever desired.

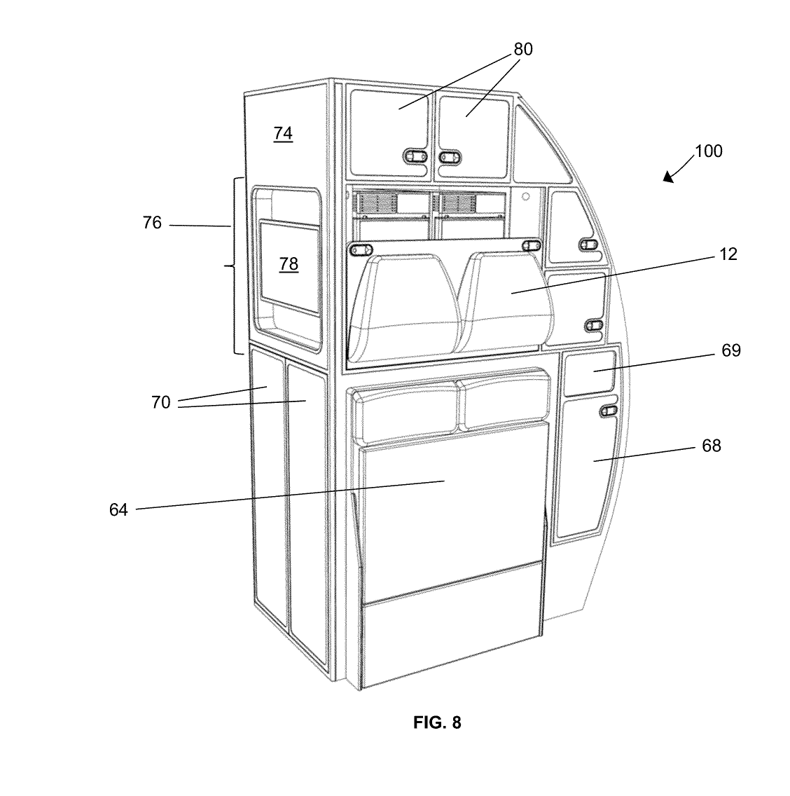

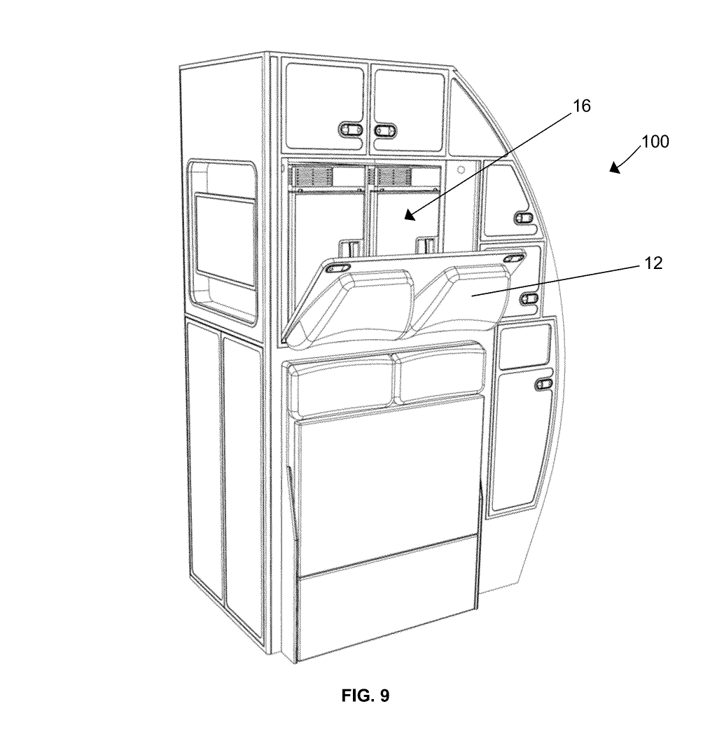

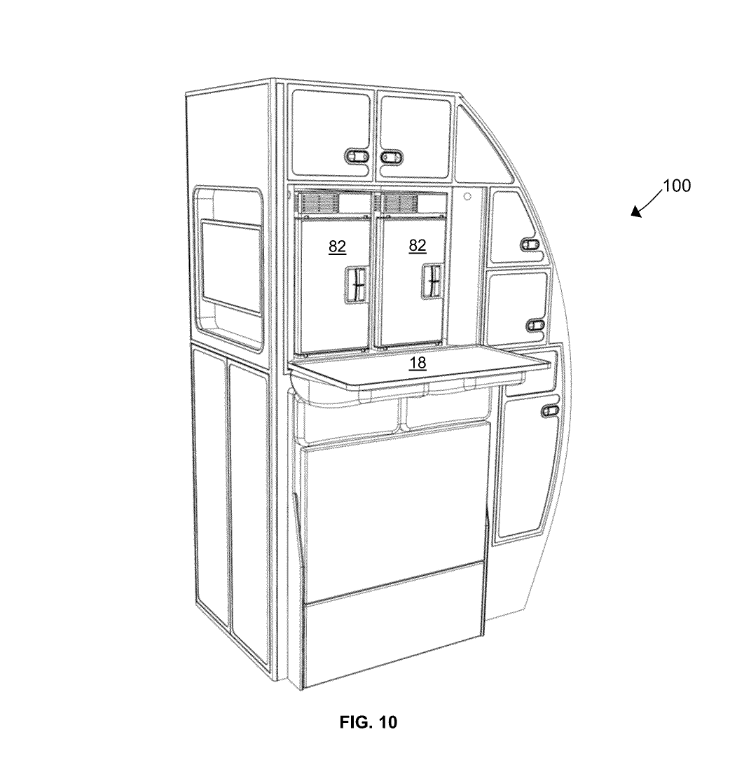

FIGS. 8-10 show a full height monument 100 with provisions for a double cabin attendant seat 64, a waste compartment 68 and chute 69, a double lower storage space 70 area on one side 74, a display area 76, upper front storage units 80, and a hidden storage space 16 behind the headrests 12. As described, these features may be customizable, depending upon what the airline's particular needs entail. The example shown may be designed to be 10 inches wide, 15 inches wide, 28 inches wide, or any other standard size or customized size as desired.

Although the monuments are described and shown as having storage spaces as well as attendant seats (and in some options, hidden storage in the attendant seat headrests), it should be understood that various options may be provided separately. For example, the storage spaces may be provided on a partition 62 alone, without attendant seats. Alternatively, the head rest storage on the attendant seats may be provided, with or without the additional side storage options.

It should be understood that the features described in this disclosure may be interchangeable with other features described herein. Changes and modifications, additions and deletions may be made to the structures and methods recited above and shown in the drawings without departing from the scope or spirit of the invention and the following claims.

What is claimed is:

1. A passenger transport vehicle monument, comprising:
(a) a re-configurable partition comprising one or more mounting areas and being configured to be positioned at various locations in the vehicle; and
(b) one or more storage compartments configured to be removably mounted to partition, or one or more attendant seats configured to be removably mounted to partition, or both.

2. The monument of claim 1, wherein the one or more storage compartments are mounted to the partition so that the partition comprises a clearance space that allows the monument to be inserted between seats and to accommodate an overhead storage compartment.

3. The monument of claim 1, further comprising one or more attendant seats mounted on the panel.

4. The monument of claim 1, wherein the partition comprises a fold-down table, a blind panel, an emergency equipment adapter plate, or any combination thereof.

5. The monument of claim 1, further comprising an attachment system for securing the partition at its base to a seat track and at its upper portion to a regular upper attachment of the vehicle.

6. The monument of claim 1, further comprising an attachment system for securing the one or more storage compartments to a seat track.

7. The monument of claim 1, wherein the partition can be installed at a location between cabin compartments.

8. The monument of claim 1, further comprising a waste compartment.

9. The monument of claim 1, wherein the one or more storage compartments comprises a lower storage space or an upper storage space or both that can accommodate one or more folded wheelchairs.

10. The monument of claim 1, wherein the one or more storage compartments comprise upper and lower storage spaces that are accessible from the side of the monument.

11. The monument of claim 1, wherein the monument is designed for installation on-board an aircraft.

12. An aircraft monument, comprising:
(a) an attendant seat chair portion;
(b) an attendant seat headrest portion, wherein the headrest portion comprises a panel back;
(c) a storage space behind the headrest portion,
wherein the panel back folds down to reveal a countertop surface and to allow access to the storage space.

13. The monument of claim 12, further comprising a cover panel above the head rest portion to conceal a larger storage space.

14. The monument of claim 12, wherein the storage space houses a galley component.

15. The monument of claim 12, further comprising one or more storage spaces along a side of the aircraft monument.

16. A method of reconfiguring an aircraft, comprising;
(a) providing a re-configurable partition that can serve as a stand-alone partition or that can have one or more storage compartments mounted thereto;
(b) installing the partition without the one or more storage compartments mounted thereto;
(c) mounting the one or more storage compartments to the partition when space is needed for particular flight pattern.
